(19) United States
(12) Patent Application Publication
(10) Pub. No.: US 2022/0137606 A1
(43) Pub. Date: May 5, 2022

(54) Method and System for Controlling Performance of a Batch Process in an Industrial Plant

(71) Applicant: ABB Schweiz AG, Baden (CH)

(72) Inventors: Riju V Chathuruthy, Bangalore (IN); Praveen KC, Bangalore (IN); Chandrashekhar Joshi, Bangalore (IN); Mudit Gupta, New Delhi (IN); Vinod C, Bangalore (IN)

(73) Assignee: ABB Schweiz AG, Baden (CH)

(21) Appl. No.: 17/573,803

(22) Filed: Jan. 12, 2022

Related U.S. Application Data
(63) Continuation of application No. PCT/IB2020/056645, filed on Jul. 15, 2020.

(30) Foreign Application Priority Data
Jul. 15, 2019 (IN) 201941028440

(51) Int. Cl. G05B 19/418

(52) U.S. Cl. CPC G05B 19/41875; G05B 2219/32077; G05B 2219/31455; G05B 2219/31265

(57) ABSTRACT

A method and industrial automation system for controlling performance of batch process includes obtaining operational data and Key Performance Indicators (KPI's) for a batch process. The operational data is provided with an absolute timestamp such that absolute timestamp associated with operational data and KPI's is converted to time duration relative to predefined event. The obtained operational data and KPI's, and reference set of operational data and KPI's are aligned based on time duration relative to a predefined event. The method comprises comparing aligned operational data and the KPI's with the reference set of KPI's and operational data. Based on comparison, one or more reference batches are determined. The method comprises identifying one reference batch based on predefined criteria. Thereby, the method involves controlling performance of batch process by providing modified setpoints based on identified reference batch.

### CROSS-REFERENCE TO RELATED APPLICATIONS

This patent application claims the benefit of Indian Patent Application No. 201941028440, filed on Jul. 15, 2019, and International Patent Application No. PCT/M2020/056645, filed on Jul. 15, 2020, both incorporated by reference herein for all purposes.

### FIELD

The present invention relates in general to process control in industrial plants. More particularly, the present invention relates to controlling performance of a batch process in an Industrial plant.

### BACKGROUND OF THE DISCLOSURE

An industrial automation system such as a Distributed Control Systems (DCS) control system is used in a variety of process industries, such as industries in the fields of chemical, petrochemical, refining, pharmaceutical, food and beverages, energy, cement, water, oil and gas, pulp and paper, steel. The automation system is used to monitor and control various industrial processes by configuring different industrial equipment associated with the respective industrial processes.

The industrial processes can be classified depending on output of the process as continuous processes, discrete processes, and batch processes. Essentially, a batch process involves production of identical products in groups (batches). The groups/batches of the product remain together while passing from one stage of production to another, until all processes are completed. Generally, in the batch processes, a process which terminates with producing the product before additional raw materials can be input for the next batch production. Examples of such batch processes include, production of biochemicals, and production of pharmaceutical products. The processes at each stage of the batch process need to be continuously monitored and analyzed for improving productivity and quality of each process in process areas.

Generally, the industrial processes are controlled by monitoring and comparing Key Performance Indicators (KPI's) of each process with the KPI's of historic processes. The comparison of the processes is analyzed and represented in the form of graph trends, which helps in identifying deviations in the processes. Currently, the graph trends indicate time series data of the KPI's with respect to absolute time. The absolute time refers to real-world time or wall-clock time. The KPI's for the historic processes is captured at different instances of absolute time in the industrial plant. As an example, the KPI's for a process may be captured at one process equipment from 6:30 PM-8.30 PM and from another process equipment from 3.30 PM-4.30 PM. Thus, the KPI's for a process is recorded at different instances of time period. The KPI's stored at different time instances cause difficultly in comparing the KPI's in real-time across previously stored processes.

Generally, the KPI's for the processes are archived for each specific process stage along with events corresponding in each stage. Thus, the graph trends are analyzed for each process respective to the events. Currently, the events associated with each process are also stored with respect to absolute times. Additionally, the industrial plant may include many automation control systems, each for a specific or group of operations. It becomes difficult to collate information and match different time stamps from different control systems. Hence, it is challenging to collate the KPI's, events and other data across the industrial plant for performance monitoring.

### BRIEF SUMMARY OF THE DISCLOSURE

The present disclosure relates to a method and an industrial automation system for controlling performance of a batch process in an industrial plant. The industrial plant can be one of, but not limited to, industries in the fields of chemical, petrochemical, refining, pharmaceutical, food and beverages, energy, cement, water, oil and gas, pulp and paper, steel, and/or the like. The industrial plant includes multiple processes for production of an end product. The industrial plant comprises the industrial automation system for monitoring and controlling the processes performed in the industrial plant. Typically, the industrial automation system controls process parameters related to the batch process of the industrial plant. The industrial automation system comprises a plurality of field devices, a plurality of process controllers and one or more servers. The plurality of field devices and the process controllers measure data associated with the batch process. The data is measured when the batch process is performed in the industrial plant. The measured data from the plurality of field devices and the process controllers is stored in a database.

The method of the present disclosure is implemented by the industrial automation system. The industrial automation system can be a control system such as, a Distributed Control System (DCS) associated with the industrial plant. The method comprises obtaining operational data and at least one of a plurality of Key Performance Indicators (KPI's) identified for the batch process from the plurality of field devices and the plurality of process controllers. The operational data includes information related to measured data, events and diagnostic of the batch process. Further, the operational data is obtained along with an absolute timestamp.

The absolute timestamp associated with the operational data and the at least one of the KPI's is converted to a time duration relative to a predefined event. The predefined event may include, for example, a start and stop time of the batch process. The method comprises aligning the obtained operational data and the at least one key performance indicators (KPI's), and a plurality of reference sets of operational data and KPI's based on the time duration relative to the predefined event. The reference set of the operational data and KPI's are previously stored data associated with a plurality of reference batches. The plurality of reference batches are previously executed batch processes with a range of product qualities that can be classified as optimal or non-optimal. The aligned operational data and the at least one KPI's of the batch process is compared with the plurality of reference set of KPI's and operational data.

Based on the comparison, one or more reference batch(es) among the plurality of reference batches are determined. The method further comprises identifying one reference batch from the one or more reference batch(es) based on predefined criteria. The predefined criteria may include, for example, selection of the reference batch from the one or more reference batch(es) by an operator associated with the batch process. Thereafter, the method comprises controlling the performance of the batch process by providing a modified one or more setpoint(s) for the batch process based on the identified reference batch. Thus, the setpoints for the batch process is modified according to the modified one or more setpoints in order to achieve an output from the batch process.

According to the comparison, the method comprises identifying differences between the aligned operational data and the at least one KPI's of the batch process and the plurality of reference set of KPI's and operational data. Further, the identified differences are compared against a threshold value associated with corresponding KPI and operation data.

The method comprises providing one or more human machine interfaces for one or more personnel to monitor the performance of the batch process.

Further, the method comprises providing a cloud service for processing the operational data and at least one KPI's of the batch process.

### BRIEF DESCRIPTION OF THE SEVERAL VIEWS OF THE DRAWING(S)

FIG. 1 shows an environment of an industrial plant which comprises an industrial automation system for controlling performance of a batch process, in accordance with an embodiment of the disclosure;

FIG. 2 shows a simplified representation of a plot for comparing Key Performance Indicators of a batch process with reference batches, in accordance with an embodiment of the disclosure;

FIG. 3 is a flowchart of a method for controlling performance of a batch process in an industrial plant with an industrial automation system, in accordance with an embodiment of the disclosure; and

FIGS. 4A and 4B are simplified representations of plots for selecting reference batches, in accordance with an embodiment of the disclosure.

### DETAILED DESCRIPTION OF ONE OR MORE PREFERRED EMBODIMENTS

In industrial plants such as in the case of process plants, processes such as batch processes are performed at different stages in order to obtain a desired end product. Typically, the batch processes are performed in a sequential way by adopting a predefined procedure or technique. The procedure essentially describes raw materials required and equipment configurations necessary to make a batch of products. In an embodiment, various equipment associated with the batch processes are configured to implement the procedure by subjecting the raw materials through an ordered set of process operations along an ordered path of stages, where processing is performed over a finite period of time using one or more equipment. Such an ordered path of the raw materials through specific stages constitutes a time-30 indexed trajectory from one process area to the next, leading from raw materials to complete end products.

Generally, in the process operation, a set of predefined tags/Key Performance Indicators (KPI's) are selected by an operator in the industrial plant for each of the stages of the batch process. In order to analyze performance of the batch processes, these predefined tags/KPT's of the batch processes are compared with historic data of previously executed batch processes. Essentially, the predefined set of KPI's for the batch process is captured with absolute time stamp. An absolute time stamp relates to real-time, which displays an exact date and time associated with an event. The historic data of previously executed batch processes are also available with absolute times tamp. In order to compare, the KPI's of the batch process should be matched with the historic data of previously executed batch processes present at one or more different time stamps. Hence, collating and alignment of the KPI's and other data for the batch process with the historic data of previously executed batch processes becomes difficult. Exemplary embodiments according to the present disclosure provide a method and system for controlling performance of a batch process in such environments.

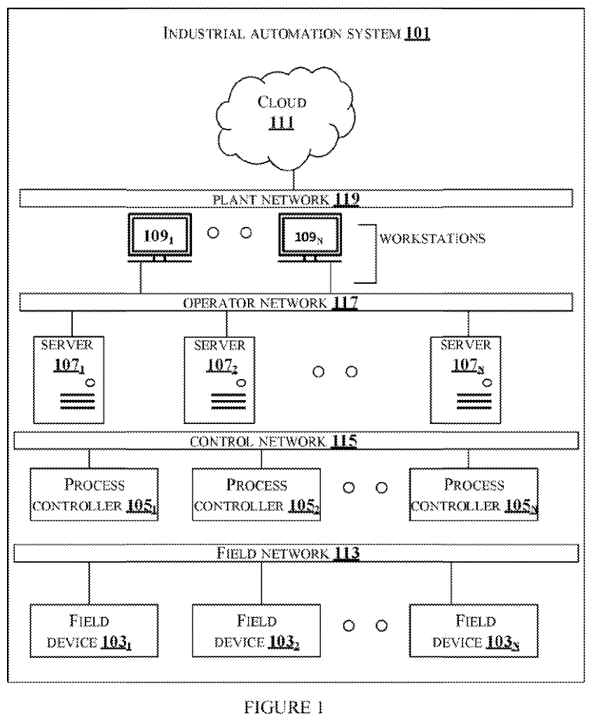

FIG. 1 shows one exemplary environment of an industrial plant, which comprises an industrial automation system 101 for controlling performance of a batch process in the industrial plant. The industrial plant may be any process plant and may include one of, but not limited to, plant in field of chemical, petrochemical, refining, pharmaceutical, food and beverages, energy, cement, water, oil and gas, pulp and paper, and steel and the like. These process plants may include a plurality of batch processes for production of products in batches. Typically, in the batch process a group/batch remains together as it passes from one stage of production to the next until all processes are complete. Examples of a batch process may include production of biochemicals, and production of pharmaceutical products, etc. Production of batch products in process plants in general will be apparent to those skilled in the art.

The industrial automation system 101 as shown in FIG. 1 comprises a plurality of field devices (denoted as 103₁, 103₂, . . . 103_{N}, and referred to collectively herein as a plurality of field devices 103). The plurality of field devices 103 is located in process environment and performs process control functions, for example, opening or closing of valves, measuring process parameters, etc. In an embodiment, the plurality of field devices 103 may include monitoring devices such as, sensors and control devices such as, valves for monitoring and controlling the batch processes in the industrial plant. Further, the industrial automation system 101 comprises a plurality of process controllers (denoted as 105₁, 105₂, . . . 105_{N}, and collectively referred to herein as a plurality of process controllers 105). The plurality of field devices 103 is communicatively connected to the plurality of process controllers 105 via fieldbus or a field network 113.

The plurality of process controllers 105 monitors and controls the batch process by sending control information to the plurality of field devices 103. Each of the plurality of process controllers 105 is connected to a plurality of servers (denoted as 107₁, 107₂, . . . 107_{N}, and collectively referred to herein as one or more servers 107) over a control network 115. The one or more servers 107 hosts current and historical data associated with respective batch processes. In an embodiment, the one or more servers 107 may also host a suite of applications associated with manufacturing operations and control operations such as Manufacturing Operations Management (MOM) and Manufacturing Execution Systems (MES), which facilitate operation management and production management of process plants. Typically, the operation and production of the batch process can be controlled by using a process procedure, which contains information necessary for configuring equipment associated with the batch process on a production line to process raw materials and produce end product. Further, the process procedure may include setpoints for configuring the equipment and maintaining one more parameter of the batch process at a specific value and within an acceptable tolerance. The process procedure stored in the one or more servers 107 may include setpoint profiles and setpoint schedules which can be sequenced towards processing of specific process batches. In an embodiment, the process procedure may be stored separately and can be downloaded to the plurality of process controllers 105.

Further, the industrial automation system 101 comprises a plurality of workstations (denoted as 109₁, 109₂, . . . 109_{N}, and collectively referred to herein as one or more workstation 109) connected to the one or more servers 107 over an operator network 117. The one or more workstation 109 may include a human machine interface for authorized operator/personnel for monitoring and visualizing performance of a current batch process. In an embodiment, the operator can intervene with one or more inputs associated with the batch process (such as specific KPI monitoring) to effect any changes in the batch process, if necessary.

Further, the industrial automation system 101 comprises a cloud platform 111 connected over a plant network 119 with the one or more workstations 109 to enable data archiving, performance management and remote diagnostics etc., for the batch processes in the industrial plant across multiple locations.

During process operation, operational data and at least one Key Performance Indicators (KPI's) associated with the batch process are obtained in real-time by the plurality of field devices 103 and the plurality of process controllers 105. The operational data includes information related to measured data, events and diagnostics of the batch process which are captured along with respective absolute timestamp. The measured data may include, but not limited to, process variable such as, pH, conductivity, temperature, pressure, etc. The events may include, one of, but not limited to, procedure errors, operator changes or modifications such as, runtime parameters changed, violation of a pre-configured condition or value etc. In an embodiment, the events may be predefined by operators. The diagnostic of the batch process may be related with health of the equipment associated with the batch process and can include, number of operating hours of an equipment, the number of opening and closing events of a valve, etc. Additionally, the operational data may be captured along with a tag ID of an equipment associated with the batch process and involved in generation of the operational data.

Essentially, the at least one KPI's associated with the batch process are configured by the operator for each of the batch process. In one embodiment, at least one of a plurality of KPI's is obtained from the plurality of process controllers 105. In another embodiment, the at least one KPT for the batch process may be identified by processing the operational data associated with the batch process. The KPI's for a batch process, for example, sintering, may include moisture content, air and gas flow rates, and KPI's for the batch process such as for process heaters may include process temperature, gross available heat, mass and chemical composition of any material melt etc. Identification of KPI's in process will be apparent to those skilled in the art. In an embodiment, start and end time of batch/material in each processing stage is provided by the industrial automation system 101 which includes a real time clock that can be synchronized with the processing of the equipment associated with the batch process.

Additionally, the operational data may also include information on units of raw materials and types of raw material used for making the batch process. This information enables backward tracking and/or forward tracking of raw materials and products of any given batch. The operational data and the at least one KPT's obtained from the plurality of field devices 103 and the plurality of process controllers 105 is provided by the process controllers 105 to the one or more servers 107.

On receiving the operational data and the at least one KPI's, the one or more servers 107 converts the absolute timestamp associated with the operational data and the at least one KPI's to a time duration relative to a predefined event. The predefined event may include start and end time of the batch process, changes made by the operator to the batch process etc. The one or more servers 107 may store information such as, a plurality of reference set of operational data and KPI's associated with a plurality of reference batches for each type of a batch process. The plurality of reference batches are previously executed batch processes with a range of product qualities.

On converting the timestamp, the one or more servers 107 may align the obtained operational data and the at least one KPI's and the plurality of reference set of operational data and KPI's based on the time duration relative to the predefined event. In an embodiment, based on a batch number/ID, the one or more servers 107 may plot trend curves for the aligned operational data and the at least one KPI's relative to the start time of the batch process. This may enable multiple trend curves of different times taken over multiple batches to be plotted on the same trend graph or plot.

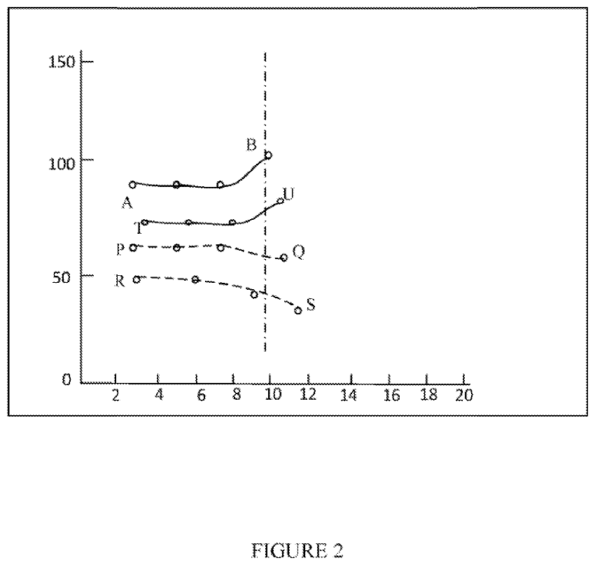

Thus, the one or more servers 107 compares the aligned operational data and the at least one KPI's of the batch process with the plurality of reference set of KPI's and operational data in the plotted trend curve. FIG. 2 shows a simplified representation of a plot for comparing Key Performance Indicators of a batch process with reference batches, in accordance with an embodiment of the disclosure. FIG. 2 shows a current trajectory “AB” followed by a batch process during the batch operation. The current trajectory “AB” is plotted using four KPI values against the relative start time of the batch process. The current trajectory “AB” or the four KPI of the batch process are compared against a trajectory “PQ,” a trajectory “RS” and a trajectory “TU” or the values associated with each such trajectories. The trajectory PQ, RS and TU are associated with reference batches.

Essentially, based on the comparison, the one or more servers 107 may determine differences such as percentage differences in value of the at least one KPI's. The percentage difference may indicate difference in the trajectory of the batch process from the plurality of reference batches. In an ideal situation, a curve for the percentage difference is a straight line on zero. However, one or more disturbances in the operation of the batch process may lead to variations. In an embodiment, the one or more disturbances can change continuously or at discrete intervals of time or they can be either slowly changing disturbances or rapidly changing. The one or more disturbances for a batch process may be, for example, raw material variability, catalyst activity variability, abrupt changes in pressure and flow, variability in process additives, sensor noise, inhomogeneities in dissolved gases such as oxygen, etc. The one or more disturbances are responsible for a lack of reproducibility and batch to batch variations in end product quality.

The one or more servers 107 may process the differences and the one or more disturbances in the operational data and at least one KPI's in the current batch process with respect to the operational data and at least one KPI's of the plurality of reference batches. In an embodiment, based on such a comparison, the one or more servers 107 may identify disturbance patterns in the current batch process which may have a higher probability of occurrence. In such scenarios, the one or more servers 107 may generate a warning, when these disturbance patterns are first beginning to appear in the batch process.

Based on the comparison, the one or more servers 107 may determine one or more reference batch(es) among the plurality of reference batches. Essentially, during the comparison, the differences identified by the one or more servers 107 between the aligned operational data and the at least one KPI's of the batch process and the plurality of reference set of KPI's and operational data are compared against a threshold value associated with corresponding KPI and operation data. Based on the comparison against the threshold value, the one or more servers 107 may select the one or more reference batch(es). Hence, when there is difference, the trend plot can display the changes. For instance, as shown in FIG. 2, based on the comparison, the trajectory PQ and RS are eliminated since the current trajectory AB is deviated from these trajectories.

Further, the trajectory “TU” is determined due to similarities in the KPI's based on the comparison. In an embodiment, the at least one KPI's can be separated into different sections or time-windows. This may help to find the KPI's which include deviation/difference through monitoring and analysis of smaller time-windows in the trend plots. The KPI's may be separated into different sections/groups according to the similarity or by user defined categories. Hence, when there is a difference/deviation, the trend curve of specific groups can be highlighted.

For example, if there are “40” KPI's to be monitored, these can be divided into five groups of eight each. For instance, the KPI values associated with parameters such as reflectivity, elastic modulus, fracture toughness, geometric defects are categorized together to indicative one single KPI, a quality KPI. Thus, all elements that make up the quality KPI can be plotted and visualized by choosing this KPI. Similarly, KPI values associated with time to failure, time to repair, utilization efficiency, production process ratio, etc., could be aggregated and categorized as an efficiency KPI. All the elements that make up the efficiency KPI can be plotted and visualized by choosing this KPI.

Further, once the one or more reference batch is/are determined, the one or more servers 107 may identify one reference batch from the one or more reference batches based on predefined criteria. The predefined criteria may include an input from the operator which indicates one reference batch among the one or more reference batches. This may involve providing the one or more reference batches to the operator. The operator may select the one reference batch among the one or more reference batches based on specific quality trend associated with the reference batch.

Additionally, the predefined criteria may be preset configuration/rules associated with the batch process for identifying one suited reference batch for the batch process. Once the reference batch is determined, the one or more servers 107 may provide the one or more setpoints identified based on the identified reference batch to the plurality of process controllers 105 for controlling the performance of the batch process. Thus, the one or more setpoints of the batch process are modified by the plurality of field devices 103 under the instructions of respective process controllers in order to produce product of the quality as that of the reference batch.

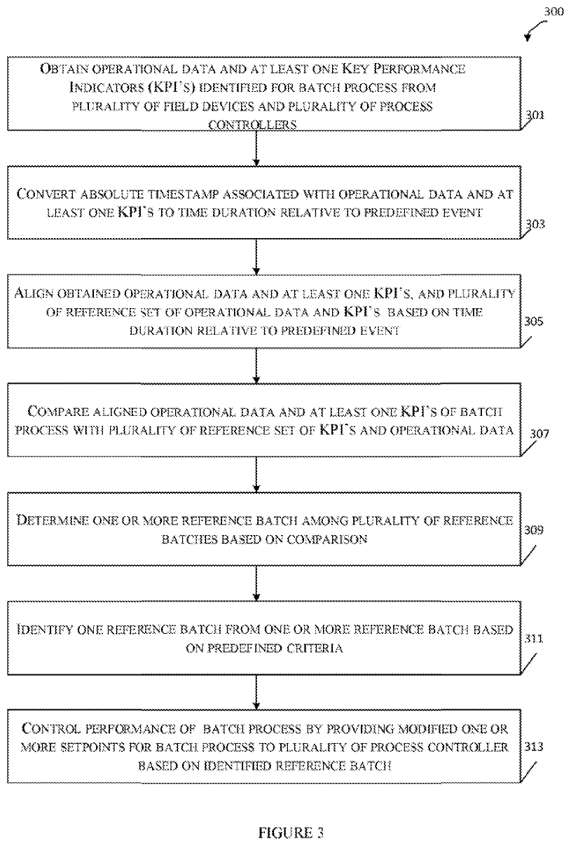

Referring now to FIG. 3, which is a flowchart of a method for controlling performance of a batch process in an industrial plant, in accordance with an embodiment of the present disclosure. Various steps of the method may be performed by the industrial automation system 101, or at least in part by the industrial automation system 101.

At 301, the operational data and the at least one KPI's identified for the batch process is obtained from the plurality of field devices 103 and the plurality of process controllers 105. The operational data is received with the absolute timestamp.

At 302, the absolute timestamp associated with the operational data and the at least one KPT's is converted by the one or more servers 107 to the time duration relative to the predefined event. The predefined event may include for example, the start and end time of the batch process. In an embodiment, the conversion of the absolute timestamp to a relative timestamp may be performed using any existing known conversion techniques.

At 303, the obtained operational data and the at least one KPI's, and the plurality of reference set of operational data and KPI's are aligned by the one or more servers 107 based on the time duration relative to the predefined event. In an embodiment, the aligned operational data and the at least one KPI's are plotted as trend curve.

At 304, the aligned operational data and the at least one KPI's of the batch process is compared by the one or more servers 107 with the plurality of reference set of KPI's and operational data. The comparison of the operational data and the at least one KPI's involves identifying differences between the aligned operational data and the at least one KPI's of the batch process and the plurality of reference set of KPI's and operational data and comparing the identified differences against the threshold value associated with corresponding KPI and operation data. Essentially, with the plotted trend curve, the one or more servers 107 may involve comparison by pattern matching against the plurality of reference. In an embodiment, the pattern matching can be performed using statistical or/and structural approaches using standard libraries.

At 305, the one or more reference batch among the plurality of reference batches is determined by the one or more servers 107 based on the comparison. The one or more reference batches are determined based on the pattern matching. Essentially, based on the pattern matching, the one or more reference batch with trajectory different from the trajectory of the batch process is/are eliminated.

At 307, the one reference batch from the one or more reference batch are identified by the one or more servers 107 based on the predefined criteria. The predefined criteria may include the inputs regarding identification of the reference batch from the operator and the predefined rules which may be configured to identify the reference batch for the batch process.

At 309, the performance of the batch process is controlled by the one or more servers 107 by providing the modified one or more setpoints for the batch process to the plurality of process controllers 105 based on the identified reference batch. Thus, the one or more servers 107 can recommend changes in setpoints of the batch process in order to navigate from one reference batch to another. This recommendation may be arrived at from the analysis of various historical trends of various reference batches.

This involves an iterative method of tuning the setpoints of the batch process and repeating the pattern matching with the plurality of reference batches to identify other possible reference batches that the current batch process can be aligned to through appropriate modifications to the setpoints.

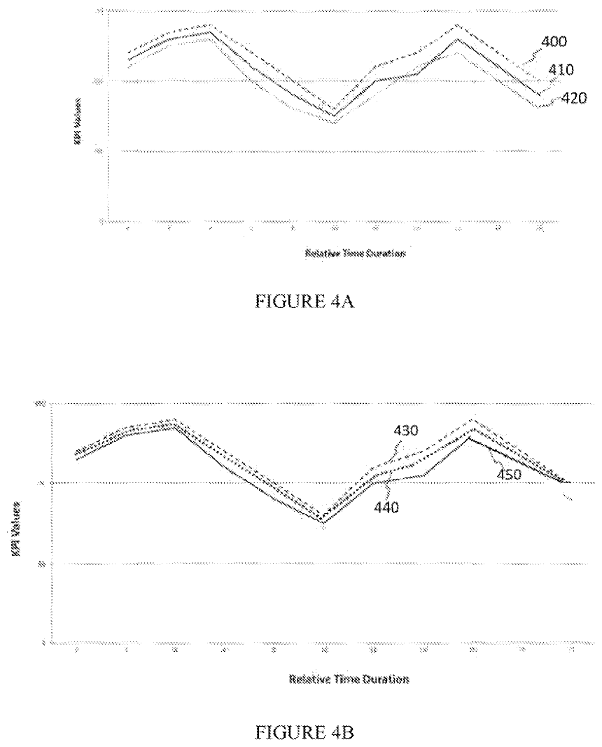

A representation of such reference curves is shown in FIG. 4A. The ordinate axes in FIG. 4A represents the KPI values and abscissa axes represents the relative time duration of the batch process. With reference to FIG. 4A, a curve 410 may represent an ongoing batch process which has been pattern matched. Two other alternate curves 400 and 420 have also been identified such that modification in the setpoints associated with ongoing batch process curve 410 can lead to alternate process curves 400, 420 and their corresponding end product quality.

Furthermore, as represented in FIG. 4B, the reference curves can be modified, for instance, by taking an average of two curves. As shown in FIG. 4B, two process curves 430, 450 appear to converge to same product quality as indicated by the convergence of the two KPI curves corresponding to different batches. Therefore, instead of treating the curves 430 and 450 as two separate ones, the one or more servers 107 may average the two curves 430 and 450 and form a new curve 440 which represents an updated reference curve. The updated reference curves may also include updated tolerance values to incorporate the two other curves 430 and 450 as leading to the same quality of the end product.

In some embodiments, the method also includes one or more human machine interface for the personnel to monitor the performance of the batch process. In some embodiment, the method also includes providing a cloud service for processing the operational data and at least one KPI's of the batch process.

The present disclosure enables controlling performance of batch processes in the industrial plant efficiently.

The present disclosure recommends changes to process values of the batch process to obtain a new reference target curve which corresponds to a new desired end product quality.

The present disclosure redefines a new reference curve, if one or more prior reference curves converge to the same end product quality.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of controlling a performance of a batch process in an industrial plant with an industrial automation system, wherein the industrial automation system comprises a plurality of field devices, a plurality of process controllers and one or more servers, wherein the industrial automation system is configured to control process parameters related to the batch process of the industrial plant, the method comprising:
obtaining operational data and at least one Key Performance Indicator (KPI) identified for the batch process from the plurality of field devices and the plurality of process controllers, wherein the operational data is information related to measured data, events and diagnostic of the batch process and wherein the operational data is provided with an absolute timestamp;
converting the absolute timestamp associated with the operational data and the at least one KPI to a time duration relative to a predefined event;
aligning the obtained operational data and the at least one key performance indicator (KPI), and a plurality of reference set of operational data and KPI based on the time duration relative to the predefined event, wherein the reference set of the operational data and KPI are previously stored data associated with a plurality of reference batches;
comparing the aligned operational data and the at least one KPT's of the batch process with a plurality of reference set of KPI and operational data;
determining one or more reference batch among the plurality of reference batches based on the comparison;
identifying one reference batch from the one or more reference batch based on predefined criteria; and
controlling the performance of the batch process by providing a modified one or more setpoints for the batch process to the plurality of process controllers based on the identified reference batch.

2. The method recited in claim 1, further comprising one or more human machine interfaces for one or more personnel to monitor the performance of the batch process.

3. The method as recited in claim 1, further comprising providing a cloud service for processing the operational data and at least one KPI of the batch process.

4. The method as recited in claim 1, wherein the comparison comprises:
identifying differences between the aligned operational data and the at least one KPI of the batch process and the plurality of reference set of KPI and operational data; and
comparing the identified differences against a threshold value associated with corresponding KPI and operation data.

5. An industrial automation system for controlling performance of a batch process in an industrial plant, wherein the industrial automation system is configured to control process parameters related to the batch process of the industrial plant, and wherein the industrial automation system comprises:
a plurality of field devices and process controllers for measuring data associated with the batch process;
one or more servers configured to:
obtain operational data and at least one Key Performance Indicator (KPI) identified for the batch process from the plurality of field devices and the process controllers, wherein the operational data is information related to measured data, events and diagnostic of the batch process and wherein the operational data is provided with an absolute timestamp;
convert the absolute timestamp associated with the operational data and the at least one KPI to a time duration relative to a predefined event;
align the obtained operational data and the at least one key performance indicator (KPI), and a plurality of reference set of operational data and KPI based on the time duration relative to the predefined event, wherein the reference set of the operational data and KPI are previously stored data associated with a plurality of reference batches;
compare the aligned operational data and the at least one KPI of the batch process with a plurality of reference set of KPI and operational data;
determine one or more reference batch among the plurality of reference batches based on the comparison;
identify one reference batch from the one or more reference batch based on predefined criteria; and
control the performance of the batch process by providing a modified one or more setpoints for the batch process to the plurality of process controller based on the identified reference batch.

6. The industrial automation system recited in claim 5, further comprising one or more human machine interfaces for one or more personnel to monitor the performance of the batch process.

7. The industrial automation system recited in claim 5, further comprising a cloud server for processing the operational data and at least one KPI of the batch process.

8. The industrial automation system recited in claim 5, wherein the one or more servers is configured to perform the comparison by:
identifying differences between the aligned operational data and the at least one KPI of the batch process and the plurality of reference set of KPI and operational data; and
comparing the identified differences against a threshold value associated with corresponding KPI and operation data.
